(19) United States
(12) Patent Application Publication
(10) Pub. No.: US 2004/0008859 A1
(43) Pub. Date: Jan. 15, 2004

(54) Loudspeaker having double symmetric magnet-circuits, double voice coils and double dampers

(75) Inventor: Huijun Zhao, Zhejiang (CN)

Correspondence Address: SYNNESTVEDT & LECHNER, LLP, 2600 ARAMARK TOWER, 1101 MARKET STREET, PHILADELPHIA, PA, 191072950

(73) Assignee: Speaker Electronic (Jiashan) Co., Ltd., Zhejiang (CN)

(21) Appl. No.: 10/600,954

(22) Filed: Jun. 20, 2003

(30) Foreign Application Priority Data
Jul. 1, 2002 (CN) 02112369.1

(51) Int. Cl. H04R 1/00; H04R 9/06; H04R 11/02

(52) U.S. Cl. 381/401; 381/398; 381/413

(57) ABSTRACT

The present invention provides a loudspeaker having double symmetric magnet-circuits, double voice coils and double dampers. The loudspeaker comprises a diaphragm holder, a diaphragm, an upper and a lower dampers, an annular steel magnet, a core, voice coils, an upper and a lower plate. Wherein the core is a steel magnet, the polarities of its upper and lower ends being opposite to those of the upper and lower ends of the annular steel magnet, so are two symmetric and parallel magnet-circuits formed. Thus the intensity of the magnet field in the two magnet gaps became very high because of the two magnet sources, so is the high power loudspeaker able to work normally.

### BACKGROUND OF THE INVENTION

The present invention relates to a structure of a high power loudspeaker, in particular, to a loudspeaker having double symmetric magnet-circuits, double voice coils and double dampers.

A loudspeaker generally comprises a diaphragm holder, a diaphragm, a damper, an annular steel magnet, a core, a voice coil, an upper plate and a lower plate. The core is inserted into a hole in the center of the upper plate and into the hollow section of the annular steel magnet, with an annular magnet gap formed between the upper section of the core and the upper plate. The voice coil comprises a cylindrical bobbin and a coil, with the upper end of the bobbin fixed to the diaphragm and the coil wound around the bobbin, being situated within the magnet gap. The periphery of the diaphragm is fixed to the edge of the diaphragm holder. The inner edge of the damper is fixed to the outer wall of the upper section of the bobbin, and its outer edge is fixed to the diaphragm holder. When an audio current passes through the coil, the coil vibrates axially under the action of the electromagnetic force, bringing about the diaphragm to produce a sound.

In this structure, as the upper section of the bobbin of the voice coil is fixed to the diaphragm holder via the damper and the diaphragm, while the lower end with coil wound around is suspending in the air, and the coil is of a relatively heavier weight, the lower end of the voice coil when vibrating is apt to sway radially, resulting in colliding with the upper plate or the core, producing an unusual noise. In addition, the high power loudspeaker with heavy basetone has a coil of a plurality of layers and large wire diameter, so that a large amount of heat will be produced, which is difficult to be dissipated when the speaker is operating with high power, thereby the sticking cement is subject to charring due to the raising of temperature of the coil, making the coil slackened and dispersed apart or even come off from the bobbin. Furthermore, the high power loudspeaker with heavy basetone operates with longer strokes, so is the outer edge of the damper generally designed relatively higher. When the voice coil is vibrating, since the upward and downward restoring forces of the damper are not consistent, it is liable to bring about nonlinear distortion of the loudspeaker.

A Chinese patent No. 97246403.4 disclosed a louderspeaker having double voice coils. The loudspeaker comprises double voice coils, double dampers and double magnet gaps, so it's improved of nonlinear distortion of the loudspeaker. However the two magnet gaps in thus formed magnet-circuit are joined in series between two poles of one magnet source. Because the core is not a steel magnet and only a annular steel magnet exists in the magnet-circuit, the series magnet gaps and the air in the gaps having very low magnetic conductibility, the magnetic resistance greatly increases, thus resulting in the greatly decreasing of the intensity of the magnet field and of the output power, even the sample being not able to work at all.

### SUMMARY OF THE INVENTION

The present invention provides a structure of a loudspeaker having double symmetric magnet-circuits, double voice coils and double dampers, which can prevent the radial swaying of the voice coil and has better heat dissipation and more consistent upward and downward restoring forces of the damper as well as higher intensity of the magnet field.

This kind of loudspeaker having double symmetric magnet-circuits, double voice coils and double dampers comprises a diaphragm holder, a diaphragm, an upper and a lower dampers, an annular steel magnet, a core, voice coils, an upper and a lower plate, a lower diaphragm holder and a core holder. The faces of the upper and lower ends of the annular steel magnet are fixed to the upper and lower plates respectively. The upper and lower plates have a round hole in their center respectively. The core is inserted into the holes in the center of the upper and lower plates and into the hollow section of the annular steel magnet, with an upper annular magnet gap formed between the periphery of the upper section of the core and the upper plate as well as an annular lower magnet gap formed between the core and the lower plate. The voice coil that wraps around the core comprises a cylindrical bobbin and an upper and a lower coil, with the upper end of the bobbin fixed to the diaphragm and the upper and lower coil wound around the bobbin, being situated within the upper and lower magnet gap respectively. The periphery of the diaphragm is fixed to the edge of the diaphragm holder. The inner edge of the upper damper is fixed to the outer wall of the upper section of the bobbin, and its outer edge is fixed to the diaphragm holder. The periphery of the lower end of the bobbin is fixed to the lower damper, with the outer edge of the lower damper fixed to the lower diaphragm holder. The lower diaphragm holder comprises an annular upper end face and a horn-shaped side. In the center of the core holder is a cylindrical protrusion with an annular collar around it. The upper end face of the lower diaphragm holder is fixed to the lower plate, and the lower edge of the lower diaphragm holder is fixed to the annular collar of the core holder. The lower end face of the core is fixed to the protrusion in the center of the core holder. Said core is a steel magnet, the polarities of its upper and lower ends being opposite to those of the upper and lower ends of the annular steel magnet.

Because this loudspeaker having double symmetric magnet-circuits, double voice coils and double dampers employs two symmetric magnet-circuits and two sets of coil, when the total number of the windings are the same, the number of windings of each set can be reduced to one half, so is the capacity of heat dissipation greatly increased.

In addition, as there is one damper at each end of the bobbin of the voice coil and the supporting manner is changed to be being supported at both ends, the stability of the voice coil is greatly increased when vibrating, to prevent the voice coil from swaying radially. The two dampers are arranged to be in a symmetric structure, the upward and downward restoring forces during the vibration of the voice coils become mutually complementary, so that the degree of its inconsistency can be decreased efficiently.

Furthermore, the core is a steel magnet, the upper and lower magnet gaps are formed by opposite polarities of the core and the annular steel magnet, and so are two symmetric and parallel magnet-circuits formed. Thus the intensity of the magnet field in the two magnet gaps became very high because of the two magnet sources, so is the sample able to work normally.

### BRIEF DESCRIPTION OF THE DRAWINGS

FIG. 1 is a basic structural view of the present invention;

FIG. 2 is a structural view of a lower diaphragm holder;

FIG. 3 is a structural view of a core holder;

FIG. 4 is another structural view of the present invention;

FIG. 5 is a sectional view showing the positions of the steel magnet;

FIG. 6 is a schematic view shows a mounting manner of upper and lower dampers.

### DETAILED DESCRIPTION OF THE PREFERRED EMBODIMENTS

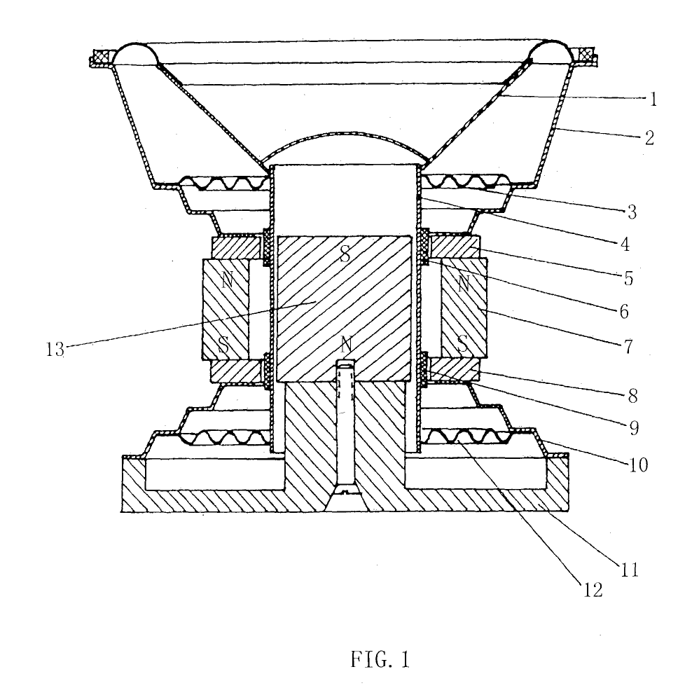

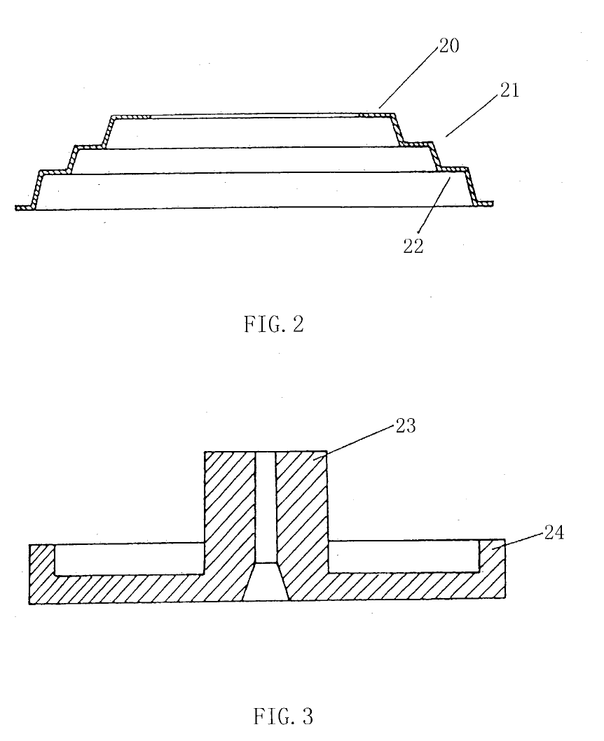

As shown in FIG. 1, the loudspeaker having double symmetric magnet-circuits, double voice coils and double dampers comprises a diaphragm 1, a diaphragm holder 2, an upper damper 3, an annular steel magnet 7, a core 13, voice coils, an upper plate 5, a lower plate 8, a lower damper 12, a lower diaphragm holder 10 and a core holder 11. The faces of the upper and lower ends of the annular steel magnet are fixed to the upper and lower plates respectively. The upper plate 5 has a round hole in its center and the lower plate 8 also has a round hole in the center. The core 13 is inserted into the hole in the center of the upper and lower plate and into the hollow section of the annular steel magnet 7, with an upper annular magnet gap formed between the periphery of the upper section of the core 13 and the upper plate 5 and with an annular lower magnet gap formed between the core 13 and the lower plate 8. The voice coil situated around the corn 13 comprises a cylindrical bobbin 4, an upper coil 6 and a lower coil 9, with the upper end of the bobbin 4 fixed to the diaphragm 1, and with the upper and lower coil wound around the bobbin 4, being situated within the upper and lower magnet gap respectively. The periphery of the diaphragm 1 is fixed to the edge of the diaphragm holder 2. The inner edge of the upper damper 3 is fixed to the outer wall of the upper section of the bobbin 4 and its outer edge is fixed to the diaphragm holder 2. The periphery of the lower end of the bobbin 4 is fixed to the lower damper 12, with the outer edge of the lower damper 12 fixed to the lower diaphragm holder 10. As shown in FIG. 2, the lower diaphragm holder 10 comprises an annular upper end face 20 and a horn-shaped side 21 with the steps 22 for sticking the lower damper on it. As shown in FIG. 3, in the center of the core holder 11 is a cylindrical protrusion 23 with an annular collar 24 around it. As shown in FIG. 1, the lower damper 12 has the same shape as the damper 3, with concentric annular corrugations distributing on it. The upper end face of the lower diaphragm holder 10 is fixed to the lower plate 8, and the lower edge of the lower diaphram holder 10 is fixed to the annular collar 24 of the core holder 11. The lower end of the core 13 is fixed to the protrusion in the center of the core holder 11. Said core 13 is a steel magnet, the polarities of its upper and lower ends being opposite to those of the upper and lower ends of the annular steel magnet 7.

This kind of loudspeaker having double symmetric magnet-circuits, double voice coils and double dampers has two symmetric magnet-circuits, two sets of coil and two dampers, being in a symmetric structure for upward and downward directions. When the total number of the windings are the same, the number of windings of each set can be reduced to one half, so is the capacity of heat dissipation greatly increased. The supporting manner of the dampers is to be supported at both ends, and these two dampers are arranged to be in a symmetric structure, so that the stability of the voice coil is greatly increased when vibrating, to prevent the voice coil from swaying radially. The upward and downward restoring forces are in a mutually complementary state, the resultant force of upward and downward directions being more consistent, so the nonlinear distortion of the loudspeaker can be reduced.

The two symmetric and parallel magnet-circuits prevent the loss of magnet field intensity, so that the intensity of magnet field in the magnet gap increase. In addition, due to total number of the windings are the same, the number of windings of each set reduce to one half, the width of the magnet gap can be decrease respectively. Thus the intensity of magnet field will be even more. Therefore efficiency of the conversion of electronic-acoustic increase a lot.

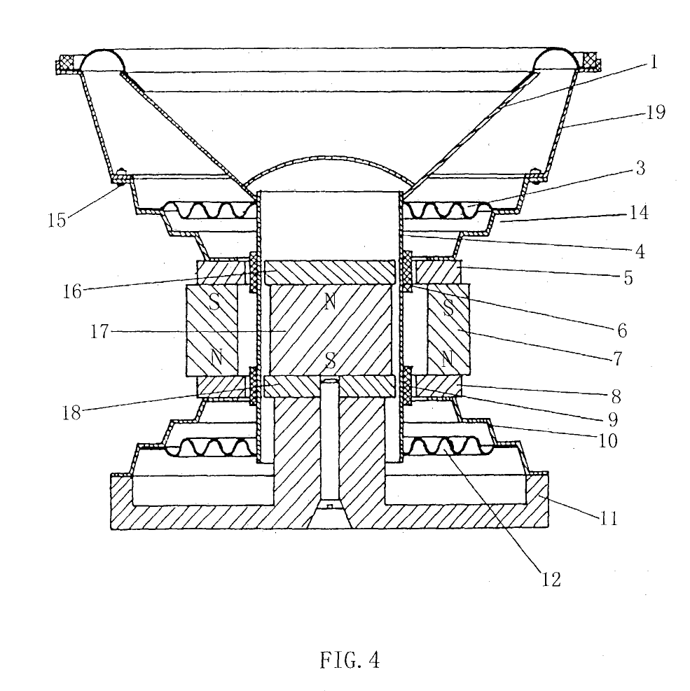

As shown in FIG. 4, the core 13 can alternatively also comprise an upper core magnet-conducting block 16, a core steel magnet 17 and a lower core magnet-conducting block 18, the upper core magnet-conducting block, the core steel magnet and the lower core magnet-conducting block being in turn stuck together, with the upper core magnet-conducting block 16 facing the upper plate 5 to form a upper magnet gap and the lower core magnet-conducting block 18 facing the lower plate 8 to form a lower magnet gap. The diameter of the steel magnet of the core is a little smaller than those of the upper and lower magnet-conducting blocks, which can make the magnet field in the magnet gaps centralized and uniformed. Furthermore the size of the magnet gap can more easily be accurately controlled in this structure.

Also as shown in FIG. 4, the diaphragm holder 2 of the present invention can also comprise an upper chassis 19 and a lower chassis 14 combined together, both chassis being fastened together by screws. The lower chassis 14 has the same shape as the lower diaphragm holder 10 of the diaphragm holder except that the orientations are opposite. The lower chassis 14 and the lower diaphragm holder are interchangeable so as to easily assembled.

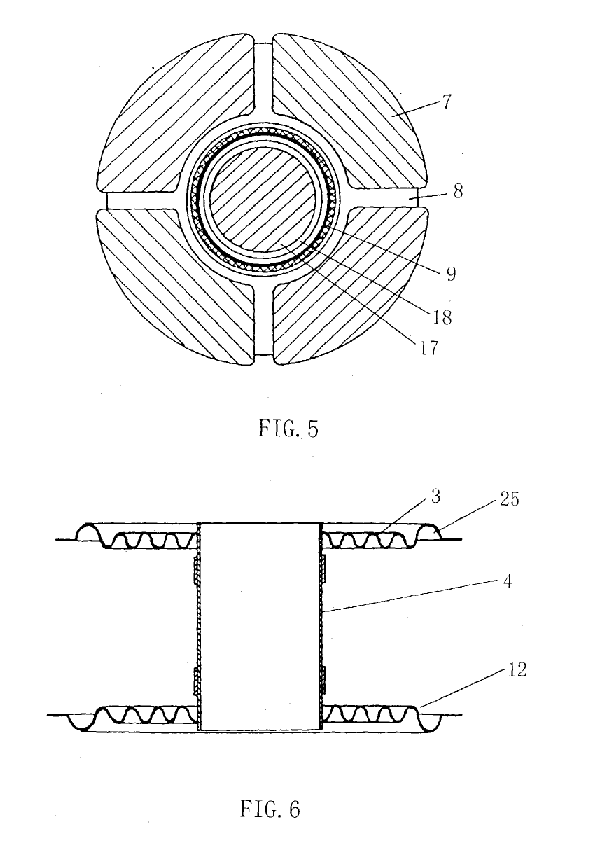

As shown in FIG. 5, the annular steel magnet 7 of the present invention can also comprise a plurality of magnet blocks arranged annularly so as to be convenient for the making of the steel magnet and the assemblage of the magnet-circuit. There is a certain gap between the magnetic blocks so as to dissipate the heat produced from the coils.

As to the present invention, the upper section of the voice coil is radially positioned by the diaphragm 1 and its lower section is stuck with lower damper 12, therefore in another embodiment of the invention, the upper damper is omitted with only lower damper being retained. The diaphragm 1 and lower damper 12 also can make the voice coil maintain on correct position and secure normal operation of the speaker.

1. A high power loudspeaker having double symmetric magnet-circuits, double voice coils and double dampers comprises a diaphragm holder, a diaphragm, an upper and a lower dampers, an annular steel magnet, a core, voice coils, an upper and a lower plate, the faces of the upper and lower ends of the annular steel magnet are fixed to the upper and lower plates respectively, the upper and lower plates have a hole in their center respectively, the core is inserted into the holes of the upper and lower plates and into the hollow section of the annular steel magnet, with an upper annular magnet gap formed between the periphery of the upper section of the core and the upper plate as well as an annular lower magnet gap formed between the core and the lower plate, the voice coil that wraps around the corn comprises a cylindrical bobbin and an upper and a lower coil, with the upper end of the bobbin fixed to the diaphragm and the upper and lower coil wound around the bobbin, being situated within the upper and lower magnet gap respectively; the periphery of the diaphragm is fixed to the edge of the diaphragm holder; the inner edge of the upper damper is fixed to the outer wall of the upper section of the bobbin, and its outer edge is fixed to the diaphragm holder; the periphery of the lower end of the bobbin is fixed to the lower damper, characterized in that the core is a steel magnet, the polarities of its upper and lower ends being opposite to those of the upper and lower ends of the annular steel magnet.

2. The loudspeaker according to claim 1, characterized in that the core is supported by a core holder which includes a central cylindrical protrusion which projects into the lower section of the voice coil to be fixed to the lower end of the core and an annular collar around.

3. The loudspeaker according to claim 2, characterized in that the outer edge of the lower damper fixed to a lower diaphragm holder that comprises an annular upper end face which is fixed to the lower plate and a horn-shaped side which lower edge is fixed to the annular collar of the core holder.

4. The loudspeaker according to claim 1, characterized in that the core comprises an upper magnet-conducting block, a core steel magnet and a lower magnet-conducting block, these three are stuck together in turn, with the upper magnet-conducting block facing the upper plate to form an upper magnet gap, the lower magnet-conducting block facing the lower plate to form the lower magnet gap, and the diameter of the core steel magnet being a little smaller than that of the upper and lower magnet-conducting blocks.

5. The loudspeaker according to claim 2, characterized in that the core comprises an upper magnet-conducting block, a core steel magnet and a lower magnet-conducting block, these three are stuck together in turn, with the upper magnet-conducting block facing the upper plate to form an upper magnet gap, the lower magnet-conducting block facing the lower plate to form the lower magnet gap, and the diameter of the core steel magnet being a little smaller than that of the upper and lower magnet-conducting blocks.

6. The loudspeaker according to claim 1, characterized in that the diaphragm holder comprises an upper chassis and a lower chassis, the upper and lower chassis are fixed together by screws.

7. The loudspeaker according to claim 1, characterized in that the annular steel magnet comprises a plurality of magnetic blocks arranged annularly.

8. The loudspeaker according to claim 1, characterized in that the upper damper and lower damper are provided symmetrically at the two ends of the voice coil.

9. A high power loudspeaker having double symmetric magnet-circuits, double voice coils and double dampers comprises a diaphragm holder, a diaphragm, a damper, an annular steel magnet, a core, voice coils, an upper and a lower plate, the faces of the upper and lower ends of the annular steel magnet are fixed to the upper and lower plates respectively, the upper and lower plates have a hole in their center respectively, the core is inserted into the holes of the upper and lower plates and into the hollow section of the annular steel magnet, with an upper annular magnet gap formed between the periphery of the upper section of the core and the upper plate as well as an annular lower magnet gap formed between the core and the lower plate, the voice coil that wraps around the corn comprises a cylindrical bobbin and an upper and a lower coil, with the upper end of the bobbin fixed to the diaphragm and the upper and lower coil wound around the bobbin, being situated within the upper and lower magnet gap respectively; the periphery of the diaphragm is fixed to the edge of the diaphragm holder; characterized in that the core is a steel magnet, the polarities of its upper and lower ends being opposite to those of the upper and lower ends of the annular steel magnet and the damper is fixed to the periphery of the lower end of the bobbin.

10. The loudspeaker according to claim 9, characterized in that the core is supported by a core holder which includes a central cylindrical protrusion which projects into the lower section of the voice coil to be fixed to the lower end of the core and an annular collar around.

11. The loudspeaker according to claim 10, characterized in that the outer edge of the damper fixed to a lower diaphragm holder that comprises an annular upper end face which is fixed to the lower plate and a horn-shaped side which lower edge is fixed to the annular collar of the core holder.

12. The loudspeaker according to claim 9, characterized in that the core comprises an upper magnet-conducting block, a core steel magnet and a lower magnet-conducting block, these three are stuck together in turn, with the upper magnet-conducting block facing the upper plate to form an upper magnet gap, the lower magnet-conducting block facing the lower plate to form the lower magnet gap, and the diameter of the core steel magnet being a little smaller than that of the upper and lower magnet-conducting blocks.

13. The loudspeaker according to claim 10, characterized in that the core comprises an upper magnet-conducting block, a core steel magnet and a lower magnet-conducting block, these three are stuck together in turn, with the upper magnet-conducting block facing the upper plate to form an upper magnet gap, the lower magnet-conducting block facing the lower plate to form the lower magnet gap, and the diameter of the core steel magnet being a little smaller than that of the upper and lower magnet-conducting blocks.

14. The loudspeaker according to claim 9, characterized in that the diaphragm holder comprises an upper chassis and a lower chassis, the upper and lower chassis are fixed together by screws.

15. The loudspeaker according to claim 9, characterized in that the annular steel magnet comprises a plurality of magnetic blocks arranged annularly.
